(19) United States
(12) Patent Application Publication
(10) Pub. No.: US 2013/0269334 A1
(43) Pub. Date: Oct. 17, 2013

(54) POWER PLANT WITH CLOSED BRAYTON CYCLE

(71) Applicants: Chandrashekhar Sonwane, Canoga Park, CA (US); Kenneth M. Sprouse, Canoga Park, CA (US)

(72) Inventors: Chandrashekhar Sonwane, Canoga Park, CA (US); Kenneth M. Sprouse, Canoga Park, CA (US)

(21) Appl. No.: 13/448,874

(22) Filed: Apr. 17, 2012

(51) Int. Cl. F02G 1/043; F02C 6/00; F02G 1/055

(52) U.S. Cl. 60/525

(57) ABSTRACT

A power plant includes a heated fluid, a closed loop, super-critical carbon dioxide-based Brayton cycle, and a closed loop, steam-based Rankine cycle. At least one heat exchanger is arranged to receive the heated fluid and exchange heat between the heated fluid, the closed loop super-critical carbon dioxide-based Brayton cycle and the closed loop, steam-based Rankine cycle.

### BACKGROUND

This disclosure relates to high-efficiency power plants. Existing power plants, such as those based on natural gas, utilize heated combustion products from the natural gas to generate steam. The steam is then used to drive a turbine, which in turn drives a generator to produce electricity. In general, the steam-based cycle is based on prior-existing technology and has relatively low efficiency.

### SUMMARY

A power plant according to an exemplary aspect of the present disclosure includes a heated fluid, a closed loop, super-critical carbon dioxide-based Brayton cycle, a closed loop, steam-based Rankine cycle and at least one heat exchanger arranged to receive the heated fluid and exchange heat between the heated fluid, the closed loop, super-critical carbon dioxide-based Brayton cycle and the closed loop, steam-based Rankine cycle.

In a further non-limiting embodiment of the any of the foregoing embodiments, the closed loop, super-critical carbon dioxide-based Brayton cycle includes at least a turbine and a compressor arranged to receive expanded carbon dioxide from the turbine, and a condenser.

In a further non-limiting embodiment of the any of the foregoing embodiments, the closed loop, steam-based Rankine cycle includes at least a turbine and a condenser.

A further non-limiting embodiment of the any of the foregoing embodiments includes a heat source operable to emit the heated fluid and a supplemental heat source arranged between the heat source and the at least one heat exchanger.

A further non-limiting embodiment of the any of the foregoing embodiments includes a supplemental heat source arranged in the closed loop, super-critical carbon dioxide-based Brayton cycle.

In a further non-limiting embodiment of the any of the foregoing embodiments, the closed loop, super-critical carbon dioxide-based Brayton cycle includes at least a turbine and a recuperater arranged to receive expanded carbon dioxide from a turbine, the recuperater including a plurality of heat exchangers.

In a further non-limiting embodiment of the any of the foregoing embodiments, the closed loop, super-critical carbon dioxide-based Brayton cycle includes at least a turbine, a recuperater arranged to receive as a first input expanded carbon dioxide from the turbine, the recuperater including a plurality of heat exchangers, a condenser arranged to receive a portion of the carbon dioxide from the recuperater, a first compressor arranged to receive a portion of the carbon dioxide from the condenser, and a second compressor arranged to receive a remaining portion of the carbon dioxide from the recuperater, and wherein the recuperater is also arranged to receive as a second input for heat exchange with its first input the carbon dioxide from the first compressor and the second compressor.

A further non-limiting embodiment of the any of the foregoing embodiments includes a heat source operable to emit the heated fluid, and the heat source is a natural gas-based heat source.

A further non-limiting embodiment of the any of the foregoing embodiments includes a heat source operable to emit the heated fluid, and the heat source is a natural gas-based power generator including at least a compressor, a turbine and a generator coupled to a common shaft, and a combustor arranged in fluid communication with the compressor and the turbine.

In a further non-limiting embodiment of the any of the foregoing embodiments, the at least one heat exchanger includes a three-way heat exchanger fluidly connected with the heated fluid, the closed loop, super-critical carbon dioxide-based Brayton cycle and the closed loop, steam-based Rankine cycle.

A power plant according to an exemplary aspect of the present disclosure includes a natural gas-based power generator including at least a first compressor, a first turbine and a generator coupled to a common shaft, and a combustor arranged in fluid communication with the first compressor and the first turbine, the natural gas-based power generator operable to emit a heated fluid from the first turbine, a first closed loop cycle including at least a second turbine and a second compressor arranged to receive expanded working fluid from the second turbine, the second turbine and the second compressor being coupled to the common shaft, a second closed loop cycle including at least a third turbine coupled to the common shaft, and a condenser, and at least one heat exchanger arranged to receive the heated fluid and exchange heat between the heated fluid, the first closed loop cycle and the second closed loop cycle.

A further non-limiting embodiment of the any of the foregoing embodiments includes a supplemental heat source arranged between the natural gas-based power generator and the at least one heat exchanger.

A further non-limiting embodiment of the any of the foregoing embodiments includes a supplemental heat source arranged within the first closed loop cycle.

In a further non-limiting embodiment of the any of the foregoing embodiments, the first closed loop cycle is a closed loop, super-critical carbon dioxide-based Brayton cycle and the second closed loop cycle is a closed loop, steam-based Rankine cycle.

In a further non-limiting embodiment of the any of the foregoing embodiments, the closed loop, super-critical carbon dioxide-based Brayton cycle includes a recuperater arranged to receive the working fluid from the second turbine, the recuperater including a plurality of heat exchangers.

A method of operating a power plant according to an exemplary aspect of the present disclosure includes thermally exchanging heat from a heat source through at least one heat exchanger into a closed loop, super-critical carbon dioxide-based Brayton cycle and a closed loop, steam-based Rankine cycle.

A further non-limiting embodiment of the any of the foregoing embodiments includes modulating amounts of electrical power provided by the closed loop, super-critical carbon dioxide-based Brayton cycle and the closed loop, steam-based Rankine cycle by selectively thermally exchanging the heat from the heat source into the closed loop, super-critical carbon dioxide-based Brayton cycle and the closed loop, steam-based Rankine cycle.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 shows an example power plant.

FIG. 2 shows another example power plant.

### DETAILED DESCRIPTION OF THE PREFERRED EMBODIMENT

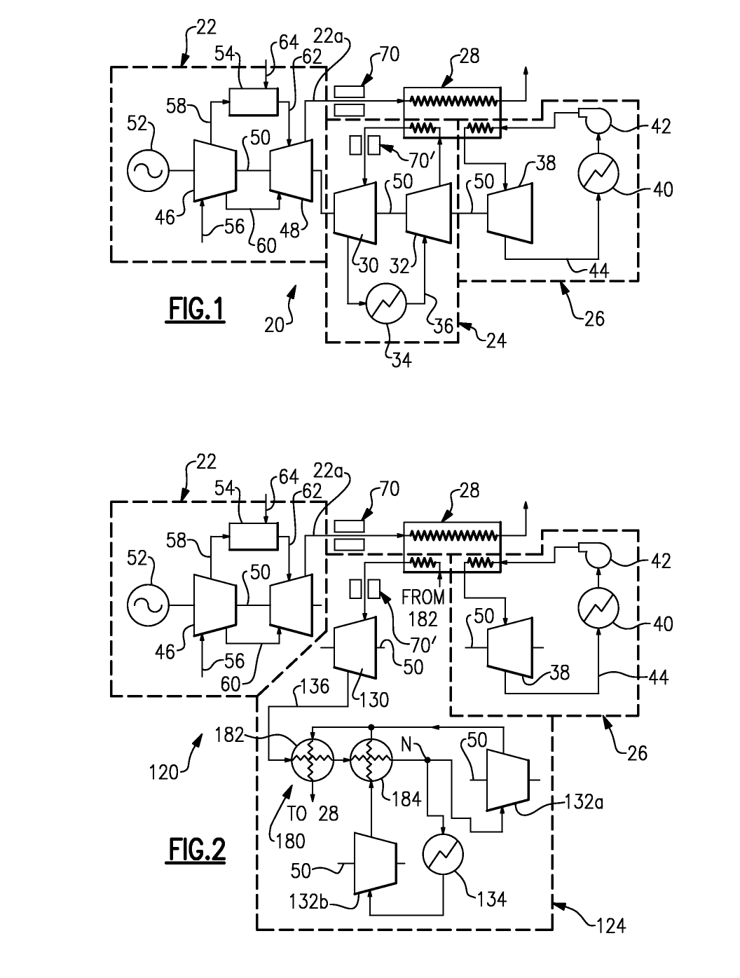

FIG. 1 shows selected portions of an example power plant 20. As will be described, the power plant 20 operates at higher efficiencies than prior-existing power plants and also lowers carbon dioxide emissions per unit of electricity produced.

In the illustrated example, the power plant 20 includes a heat source 22 that is operable to emit a heated fluid (e.g., combustion gases) through line 22a, a first closed loop cycle 24 and a second closed loop cycle 26. The respective components of the heat source 22, first closed loop cycle 24 and a second closed loop cycle 26 are generally enclosed within the dashed line boxes shown in the drawing. At least one heat exchanger 28 is arranged to receive the heated fluid through line 22a and exchange heat to the first closed loop cycle 24 and the second closed loop cycle 26. Although only a single heat exchanger 28 is shown, it is to be understood that two or more heat exchangers 28 may alternatively be used. The term “closed loop” as used herein refers to a system that does not rely on matter exchange from outside of the system and thus, the working fluid that circulates within the system is contained within the loop.

In the illustrated example, the first closed loop cycle 24 is a closed loop, super-critical carbon dioxide-based Brayton cycle that includes a turbine 30 and a compressor 32 that is arranged to receive expanded carbon dioxide from the turbine 30. In this example, a condenser 34 is arranged between the turbine 30 and the compressor 32, downstream from the turbine 30. The carbon dioxide-based working fluid, such as pure carbon dioxide/impurities or a mixture thereof with helium or other gas, circulates through a line 36 from the turbine 30, to the condenser 34, to the compressor 32, and through the heat exchanger 28. The first closed loop cycle 24 can be originally installed equipment of the power plant 20 or can added as a retrofit to a pre-existing power plant that already has one or more of the heat source 22 and second closed loop cycle 26. Similarly, the second closed loop cycle 26 can be originally installed equipment or an added retrofit.

In this example, the second closed loop cycle 26 is a steam-based Rankine cycle that includes at least a turbine 38 and a condenser 40 arranged to receive expanded steam from the turbine 38. The steam-based Rankine cycle also includes a pump 42 arranged downstream from the condenser 40. The water-based working fluid circulates through a line 44 from the turbine 38 to the condenser 40, to the pump 42 and through the heat exchanger 28.

In this example, the heat source 22 is a natural gas-based power generator that includes a compressor 46 and a turbine 48 that are coupled on a common shaft 50 with a generator 52. A combustor 54 is arranged in fluid communication with the compressor 46 and the turbine 48.

The heat source 22 includes an air inlet 56 leading into the compressor 46. Outlet lines 58 and 60 lead, respectively, to the combustor 54 and the turbine 48. The combustor 54 includes an outlet line 62 that leads into the turbine 48 and a natural gas inlet 64.

The turbine 30 and the compressor 32 of the first closed loop cycle 34 and the turbine 38 of the second closed loop cycle 26 are also mounted on the common shaft 50 such that the turbines 30, 38 and 48 collectively drive the generator 52 and the compressors 32 and 46. Similar to the cycles 24 and 26, the heat source 22 can be originally installed equipment or an added retrofit to replace a same or different type of heat source.

In operation, the heat source 22 receives air through the air inlet 56 into the compressor 46. A portion of the compressed air from the compressor 46 is provided to the combustor 54 through line 58 and another portion of the compressed air is provided directly into the turbine 48 through line 60. The combustor 54 receives natural gas through natural gas inlet 64 and combusts the air and the natural gas. The combustion products are provided through a line 62 for expansion over the turbine 48. The expanded combustion products are then provided as the heated fluid through line 22a into the heat exchanger 28.

In this example, the heat exchanger 28 is a three-way heat exchanger that is connected to the heat source 22 through line 22a, the first closed loop cycle 24 and the second closed loop cycle 26. In this regard, the line 36 of the first closed loop cycle 24 and the line 44 of the second closed loop cycle 26 are routed through different portions of the heat exchanger 28 to receive heat from the heated fluid transported through line 22a into the heat exchanger 28. Thus, the carbon dioxide-based working fluid circulating through line 36 can be heated within the heat exchanger 28. The heated carbon dioxide-based working fluid is then expanded over turbine 30 before being cooled in the condenser 34. The carbon dioxide-based working fluid is then provided into compressor 32 before being recirculated through the heat exchanger 28 for another thermodynamic cycle. The water-based working fluid of the second closed loop cycle 26 circulating through line 44 can also be heated within the heat exchanger 28. The heated water-based working fluid is then expanded over turbine 38 before being cooled in the condenser 40. The water-based working fluid is then provided into the pump 42 before being recirculated through the heat exchanger 28 for another thermodynamic cycle.

As can be appreciated, the hot combustion products from the heat source 22 that circulate through the heat exchanger 28 heats the carbon dioxide-based working fluid of the first closed loop cycle 24 and the water-based working fluid of the second closed loop cycle 26. The thermal energy received into the first closed loop cycle 24 and the second closed loop cycle 26 drives the respective turbines 30 and 38 to, in turn, drive the generator 52. Thus, the power plant 20 provides for efficient use of the thermal energy generated in the heat source 22 to thereby increase efficiency and lower carbon dioxide emissions per unit of electricity produced.

Additionally, the heat exchanger 28, the first closed loop cycle 24 and the second closed loop cycle 26 can be controlled, such as by controlling flow of the working fluids, to modulate the amount of power provided by each of the first closed loop cycle 24 and the second closed loop cycle 26. As an example, by controlling the percentage of heat exchanged to the first closed loop cycle 24 versus the percentage of heat exchanged to the second closed loop cycle 26 in the heat exchanger 28, the first closed loop cycle 24 can provide from 0-100% of the total combined power from the first closed loop cycle 24 and the second closed loop cycle 26. Inversely, the second closed loop cycle 26 can provide from 100-0% of the total combined power. Thus, depending on the efficiencies of each cycle 24 and 26, the power balance can be shifted to increase overall plant efficiency.

Optionally, the power plant 20 can additionally include a supplemental heat source 70 to increase the temperature of the hot combustion products from the heat source 22. In this example, the supplemental heat source 70 is provided between the heat source 22 and the heat exchanger 28 to heat the hot combustion products prior to entering into the heat exchanger 28. Thus, additional thermal energy is input for heat exchange with the first closed loop cycle 24 and the second closed loop cycle 26.

Alternatively, or in addition to the supplemental heat source 70, a supplemental heat source 70′ can be provided within the first closed loop cycle 24. In this example, the supplemental heat source 70′ is arranged between the heat exchanger 28 and the turbine 30 such that carbon dioxide-based working fluid from the heat exchanger 28 is additionally heated prior to input into the turbine 30. As an example, the supplemental heat source 70 or 70′ is an additional natural gas-based heat source, electrical heat source or other type of heat source.

FIG. 2 shows another example power plant 120. In this disclosure, like reference numerals designate like elements where appropriate and reference numerals with the addition of one-hundred or multiples thereof designate modified elements that are understood to incorporate the same features and benefits of the corresponding elements. In this example, the power plant 120 is similar to the power plant 20 with the exception that the first closed loop cycle 124 is a recuperative closed loop, super-critical carbon dioxide-based Brayton cycle.

The first closed loop cycle 124 includes a turbine 130 and a recuperater 180 that is arranged to receive expanded carbon dioxide-based working fluid from the turbine 130. In this example, the recuperater 180 includes a plurality of heat exchangers including a first heat exchanger 182 and a second heat exchanger 184. The first closed loop cycle 124 additionally includes a first compressor 132a and a second compressor 132b as well as a condenser 134.

The first heat exchanger 182, which is considered a high temperature recuperater, receives as a first input expanded carbon dioxide-based working fluid from the turbine 130. The second heat exchanger 184, which is considered a low temperature recuperater, is arranged to receive the expanded carbon dioxide-based working fluid from the first heat exchanger 182 as a first input.

Downstream from the second heat exchanger 184, the carbon dioxide-based working fluid splits at node N such that a portion of the carbon dioxide-based working fluid goes to the condenser 134 and a remaining portion goes to the first compressor 132a. The portion provided to the condenser 134 is cooled and then provided to the second compressor 132b. The first compressor 132a compresses the remaining portion and provides the compressed carbon dioxide-based working fluid back into the first heat exchanger 182 as a second input. The compressed carbon dioxide-based working fluid from the second compressor 132b is provided into the second heat exchanger 184 as a second input before circulating back through the first heat exchanger 182 as a portion of the second input. The carbon dioxide-based working fluid is then output from the first heat exchanger 182 into the heat exchanger 28 for another thermodynamic cycle through the line 136.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A power plant comprising:
a heated fluid;
a closed loop, super-critical carbon dioxide-based Brayton cycle;
a closed loop, steam-based Rankine cycle; and
at least one heat exchanger arranged to receive the heated fluid and exchange heat between the heated fluid, the closed loop, super-critical carbon dioxide-based Brayton cycle and the closed loop, steam-based Rankine cycle.

2. The power plant as recited in claim 1, wherein the closed loop, super-critical carbon dioxide-based Brayton cycle includes at least a turbine and a compressor arranged to receive expanded carbon dioxide from the turbine, and a condenser.

3. The power plant as recited in claim 1, wherein the closed loop, steam-based Rankine cycle includes at least a turbine and a condenser.

4. The power plant as recited in claim 1, further including a heat source operable to emit the heated fluid and a supplemental heat source arranged between the heat source and the at least one heat exchanger.

5. The power plant as recited in claim 1, further including a supplemental heat source arranged in the closed loop, super-critical carbon dioxide-based Brayton cycle.

6. The power plant as recited in claim 1, wherein the closed loop, super-critical carbon dioxide-based Brayton cycle includes at least a turbine and a recuperater arranged to receive expanded carbon dioxide from a turbine, the recuperater including a plurality of heat exchangers.

7. The power plant as recited in claim 1, wherein the closed loop, super-critical carbon dioxide-based Brayton cycle includes at least a turbine, a recuperater arranged to receive as a first input expanded carbon dioxide from the turbine, the recuperater including a plurality of heat exchangers, a condenser arranged to receive a portion of the carbon dioxide from the recuperater, a first compressor arranged to receive a portion of the carbon dioxide from the condenser, and a second compressor arranged to receive a remaining portion of the carbon dioxide from the recuperater, and wherein the recuperater is also arranged to receive as a second input for heat exchange with its first input the carbon dioxide from the first compressor and the second compressor.

8. The power plant as recited in claim 1, further comprising a heat source operable to emit the heated fluid, and the heat source is a natural gas-based heat source.

9. The power plant as recited in claim 1, further comprising a heat source operable to emit the heated fluid, and the heat source is a natural gas-based power generator including at least a compressor, a turbine and a generator coupled to a common shaft, and a combustor arranged in fluid communication with the compressor and the turbine.

10. The power plant as recited in claim 1, wherein the at least one heat exchanger includes a three-way heat exchanger fluidly connected with the heated fluid, the closed loop, super-critical carbon dioxide-based Brayton cycle and the closed loop, steam-based Rankine cycle.

11. A power plant comprising:
a natural gas-based power generator including at least a first compressor, a first turbine and a generator coupled to a common shaft, and a combustor arranged in fluid communication with the first compressor and the first turbine, the natural gas-based power generator operable to emit a heated fluid from the first turbine;
a first closed loop cycle including at least a second turbine and a second compressor arranged to receive expanded working fluid from the second turbine, the second turbine and the second compressor being coupled to the common shaft;
a second closed loop cycle including at least a third turbine coupled to the common shaft, and a condenser; and
at least one heat exchanger arranged to receive the heated fluid and exchange heat between the heated fluid, the first closed loop cycle and the second closed loop cycle.

12. The power plant as recited in claim 11, further including a supplemental heat source arranged between the natural gas-based power generator and the at least one heat exchanger.

13. The power plant as recited in claim 11, further including a supplemental heat source arranged within the first closed loop cycle.

14. The power plant as recited in claim 11, wherein the first closed loop cycle is a closed loop, super-critical carbon dioxide-based Brayton cycle and the second closed loop cycle is a closed loop, steam-based Rankine cycle.

15. The power plant as recited in claim 14, wherein the closed loop, super-critical carbon dioxide-based Brayton cycle includes a recuperater arranged to receive the working fluid from the second turbine, the recuperater including a plurality of heat exchangers.

16. A method of operating a power plant, the method comprising:
thermally exchanging heat from a heat source through at least one heat exchanger into a closed loop, super-critical carbon dioxide-based Brayton cycle and a closed loop, steam-based Rankine cycle.

17. The method as recited in claim 16, further including modulating amounts of electrical power provided by the closed loop, super-critical carbon dioxide-based Brayton cycle and the closed loop, steam-based Rankine cycle by selectively thermally exchanging the heat from the heat source into the closed loop, super-critical carbon dioxide-based Brayton cycle and the closed loop, steam-based Rankine cycle.
